(19) United States
(12) Patent Application Publication
(10) Pub. No.: US 2008/0182228 A1
(43) Pub. Date: Jul. 31, 2008

(54) Touch Screen Device

(75) Inventors: Moustapha Hafez, Paris (FR); Mohamed Benali Koudja, Antony (FR); Nikola Vujic, Robinson (FR); Fadila Khelfaoui, Bonn (DE)

Correspondence Address: OBLON, SPIVAK, MCCLELLAND MAIER & NEUSTADT, P.C., 1940 DUKE STREET, ALEXANDRIA, VA, 22314, US

(73) Assignee: COMMISSARIAT A L'ENERGIE ATOMIQUES, PARIS FRANCE (FR)

(21) Appl. No.: 11/628,622

(22) PCT Filed: Jun. 3, 2005
(86) PCT No.: PCT/FR05/50418

§ 371 Date: Dec. 6, 2006

(30) Foreign Application Priority Data
Jun. 7, 2004 (FR) 0451119

(51) Int. Cl. G09B 21/00

(52) U.S. Cl. 434/114; 340/825.19

(57) ABSTRACT

A tactile display device includes: a touch plate with a touch surface, a network of taxels formed in solid parts of the touch plate or in solid parts of a sub-plate that forms part of the touch plate with each taxel made up of a strip that can be in at least two states, with the change from one state to another indirectly or directly modifying the tactile sensation, and a mechanism for modifying the state of the taxel strips in a selective manner, including for addressing and for modifying the taxels' tactile sensation. Each taxel strip has a spiral shape, bordered on either side by a gap in the form of a spiral.

### DESCRIPTION

### TECHNICAL FIELD

The invention relates to the field of devices designed to transmit tactile information to a user. It relates more specifically to a tactile display device comprising:
a touch plate which has a touch surface,
a network of taxels each of which is made up of a strip which can be in at least two states, with the change from one states to another setting up a change in the tactile sensation,
means of actuation the taxel strips in a selective manner, with these means including means of addressing and means of modifying the state of a taxel strip.

Deformation of the surface contours of the touch surface or causing it to vibrate or causing a change in its temperature will produce a variation in the state of the strip and therefore a variation of the tactile sensation that users are able to detect. The means of addressing are used to select micro-actuators that are it is appropriate to activate at a given point in time in order to produce at this point in time the desired tactile sensation.

### THE EXISTING TECHNICAL SITUATION

U.S. Pat No. 6,159,013 describes a portable optical sensor for the blind. The device includes an electromagnetic unit. The electromagnetic unit includes a touch plate. This plate has three holes. Moving rods centred in each of the holes can, depending on their axial position, cause the touch surface of the touch plate to deform. A coil located behind the touch plate surrounds each of the rods. Each coil is used to displace one of the rods along its axial dimension. Depending on the value of the current passing through the coil, one end of the rod does, or does not, emerge from the corresponding hole, thus modifying the shape of the touch surface. In this way a specific tactile sensation of the touch plate may be provided at any moment. For devices where the number of actuators could reach several hundred, the method described in the patent can no longer be used because of the complexity of assembly and wiring, especially in systems which must undergo miniaturisation.

### PRESENTATION OF THE INVENTION

The present invention relates to a touch plate whose taxels are each made up of a single strip cut from a solid part of a plate. The strips and the plate therefore form a single piece assembly. Each of the strips forming a taxel may be formed from the single plate by the use of volume manufacturing techniques, in particular techniques for the formation of multi-layer components in microelectronics.

The present invention aims to increase the number of taxels per surface unit in relation to current techniques. It thus aims to create a continuous sensation during tactile exploration of the touch surface. Ideally the distance between contiguous taxels on the touch surface should be of the order of 1 mm, which effectively represents the value of the mechanical resolution that can be felt by a human finger. The complexity of assembly of the tactile interface increases with the number of taxels per unit of surface area, that is, with the taxel density. This complexity increases even further where each taxel must be actuated individually in a restricted operating space whose base surface area is of the order of mm². According to the invention, the strip cut from the plate surface has a spiral shape.

Stipulations relating to the vocabulary used will be given below for information.

The term <<taxel>> is not yet widely employed outside its use by those working in the field of tactile sensation. By analogy with a pixel, it refers to the surface area of sensation modification of a tactile sensation element. The tactile sensation of the assembly is a function of the value of each taxel. The tactile sensation of a taxel may be modified by modifying its state in relation to the plane of the plate. The state may be made up of the relative position of the taxel relative to the rest of the plate or its state of immobility or of movement, for example vibration movement, or its temperature.

It is specified here that the term spiral is not restricted to, for example, a logarithmic spiral. Thus, for example, each turn of the spiral may have, for example, an effectively square, elliptical or circular shape. These examples are given for the purposes of illustration and are not restrictive.

The term “touch plate” does not necessarily designate a flat plate. The plate may be formed of stacked layers. The plate may be flat of curved, in particular in order to improve the fit with the shape of a part of the body to which the tactile sensation must be applied. In the remainder of this presentation it will be assumed that the plate is locally flat in relation to a taxel.

According to the invention the deformable parts of the taxel or pins are in the shape of a spiral, which deform out of the plane or which vibrate. This geometric shape means -that the active bar length of the pin is maximised. It therefore provides significant deflection from the plane, whilst remaining in its elastic zone, or super-elastic zone in the case of shape memory alloys, of the material which makes up the plate in which the spiral strip is cut.

In summary, the invention relates to a tactile display device comprising:
a touch plate which has a touch surface,
a network of taxels formed from a touch plate or in an sub-plate which forms part of the touch plate, where each taxel is made up of a strip which can be in at least two states, with the change from one of the states to another indirectly or directly modifying the tactile sensation,
means for modifying the state of the taxel strips in a selective manner, with these means including means of addressing and means of modifying the taxel tactile sensation.

characterised by the fact that

each taxel strip has a spiral shape, bordered on either side by a gap in the form of a spiral.

In one embodiment each taxel strip has a double spiral shape.

In one embodiment, the plate or a sub-plate which forms the touch plate with at least one other sub-plate, and the strips are made from a shape memory material, with each strip capable of two states, depending on its temperature; a first state in which the strip is in the local plane of the plate, and a second in which the strip is deformed out of the plane, thus causing a tactile surface contour sensation.

In one embodiment the plate or a sub-plate which with at least one other sub-plate makes up the touch plate and the strips are made from a dual direction shape memory material.

In one embodiment the touch plate is made of two sub-plates which are parallel to each other, one sub-plate made of shape memory material which includes the taxel network and a sub-plate made of elastic material, with the sub-plate made of elastic material including, so that they correspond with each taxel in the sub-plate made of shape memory material, a spring strip which is separated from the solid part of the sub-plate by one or more gaps and linked to it by one or more arms, with each spring strip on the sub-plate made of elastic material including a rigid mechanical link with the spiral strip of the taxel to which it corresponds so as to exert a return force on this taxel strip when this taxel strip is in its out-of-plane state.

In one embodiment the touch plate is made of two sub-plates which are parallel to each other, one sub-plate made of shape memory material which includes the taxel network and a return sub-plate also made of shape memory material, with the return sub-plate including, so that they correspond with each taxel in the sub-plate made of shape memory material which holds the taxel network, a spring strip which is separated from the solid part of the return sub-plate by one or more gaps and which is linked to it by one or more arms, with each strip on the return sub-plate being, depending on its temperature, in a rest position or in a memorised position, with each strip in the return sub-plate including a rigid mechanical link with the spiral strip of the taxel to which it corresponds so that in a memorised position the strip in the return sub-plate exerts a return force on the taxel strip to which it corresponds which tends to bring the said taxel strip to its out-of-plane state to its rest state. Optionally, a thermal insulation layer may separate the sub-plates made of shape memory material from each other, where the rigid mechanical link between one strip of the return sub-plate and the taxel strip to which it corresponds includes a thermal insulation element which is rigidly linked mechanically to a part of the taxel strip and to a part of the return sub-plate strip.

Preferably, there are grooves present in the solid part of the plate or sub-plates made of shape memory material which together form the touch plate in the spaces between two adjacent taxel strips. These grooves slow down the propagation of heat between one heated taxel strip and the contiguous taxel strip.

In one embodiment the touch plate includes a bi-layer material which includes a layer of flexible material and a layer of piezoelectric material.

Thus when an electrical field is applied to a strip, it produces a deformation in the flexion strip which causes it to deflect out of the plane of the strip. The layer of flexible material, when it is present, is used to increase the strength of the piezoelectric layer, which is for example a ceramic and very brittle in nature.

In one embodiment the touch plate is made up of a triple-layer material which includes a layer of flexible material between two layers of piezoelectric material.

In one embodiment the touch plate is made up of a bi-layer material which includes two layers of piezoelectric material.

In one embodiment the touch plate includes a layer of magnetostrictive material. This allows high torque, high-speed actuators to be made directly without the need to pass through a reducer for a vibratory tactile yield.

In one embodiment the touch plate includes a layer of electrostrictive material.

In one embodiment the taxel strip is a motor element of a rod which at the touch plate forms a modification of the tactile sensation.

In one embodiment the strips are mechanically linked to a rod which is itself mechanically linked to a magnet.

In variants of the embodiments of these last two modes, the device according to the invention in addition includes an intermediate plate made of deformable material which includes passageways for the rods. The rods are fitted with bulging parts and narrow parts, with these bulging and narrow parts fitting into internal shapes in the passageways in order to hold the rod in one or more predefined positions.

### BRIEF DESCRIPTION OF THE DIAGRAMS

Embodiments of the invention will now be described using the appended drawings, in which:

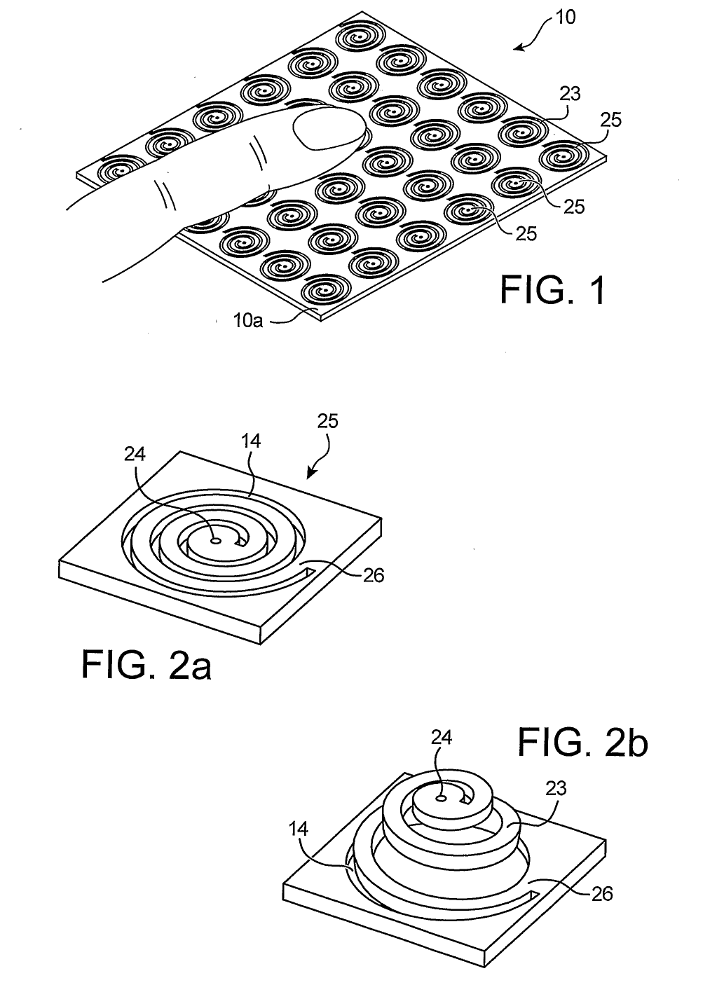

FIG. 1 shows a view of a touch plate for a display device according to the invention in the presence of a finger,

FIGS. 2a and 2b respectively represent the details of a taxel in the rest position and in the out-of-plane position.

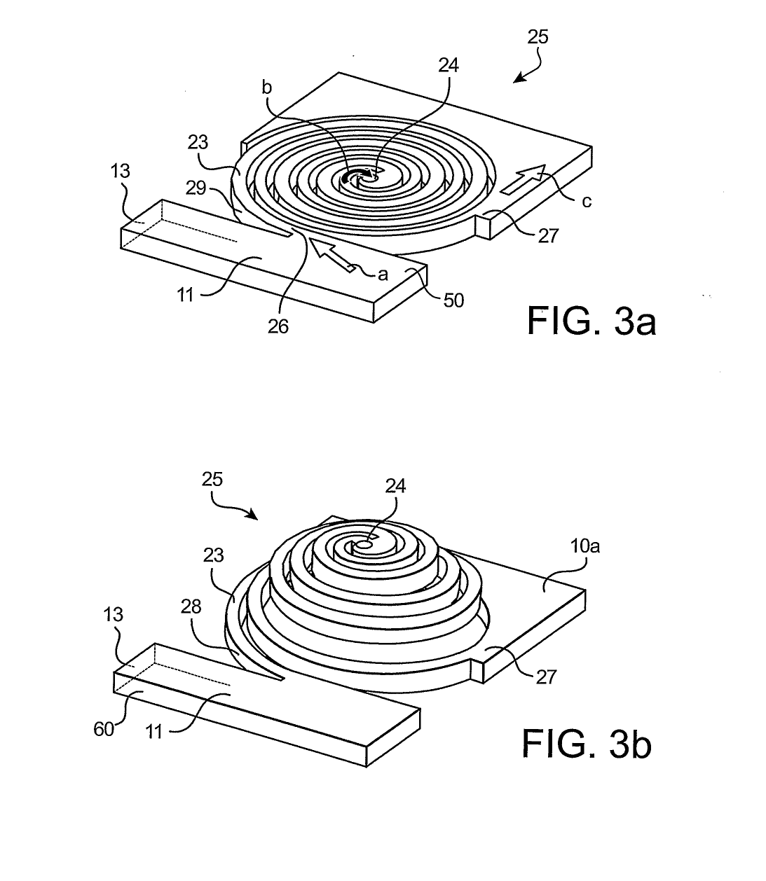

FIGS. 3a and 2b respectively represent the details of a taxel in the rest position and in the out-of-plane position in the case where the strip is a double spiral,

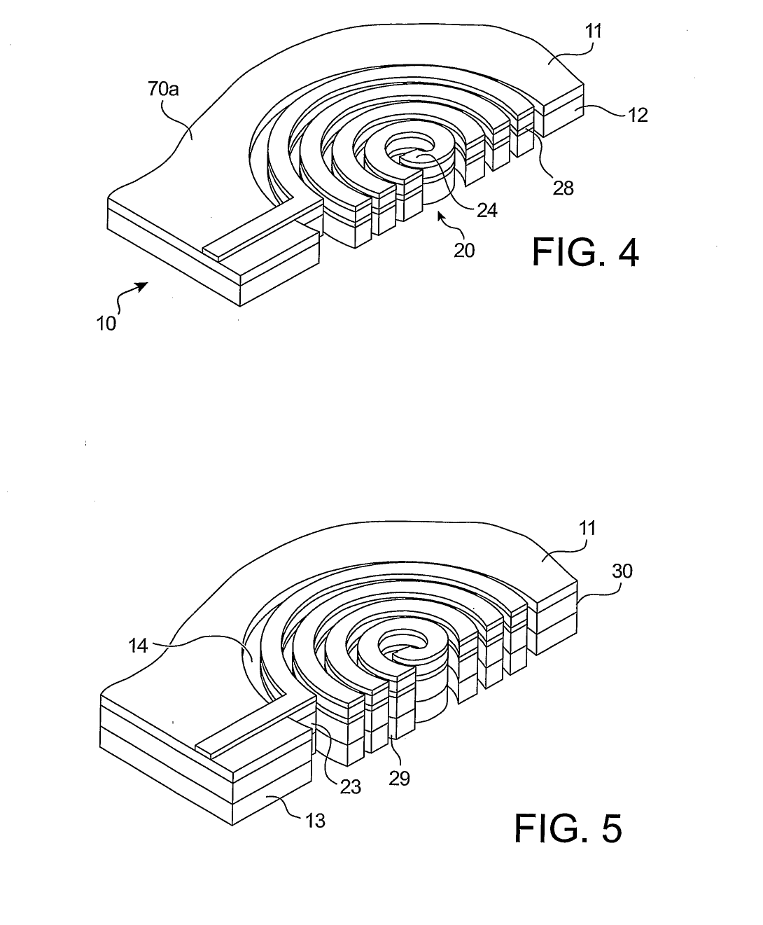

FIG. 4 represents a cross-section and perspective view of a taxel with an elastic means of return to the rest position present, with the taxels shown in a solid part of the first sub-layer made of shape memory, piezoelectric, electrostrictive or magnetostrictive material and the means of return which is shown in a full part of a second sub-plate made of elastic material which mechanically firmly fixed to the first sub-plate.

FIG. 5 shows a section in perspective of a taxel formed in a solid part of a plate in the presence of a means of return to a rest position made from shape memory material which has a memorised shape which is antagonistic to the memorised shape in the plane.

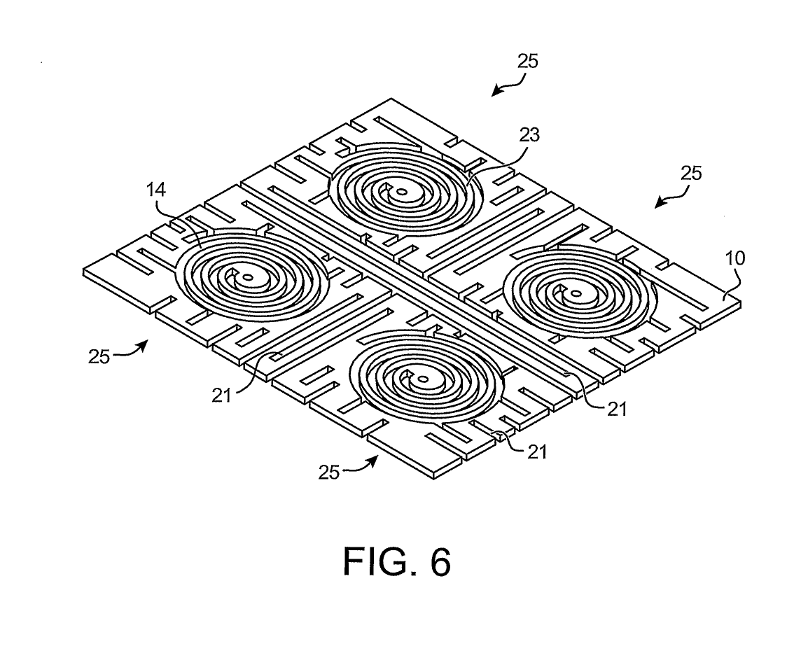

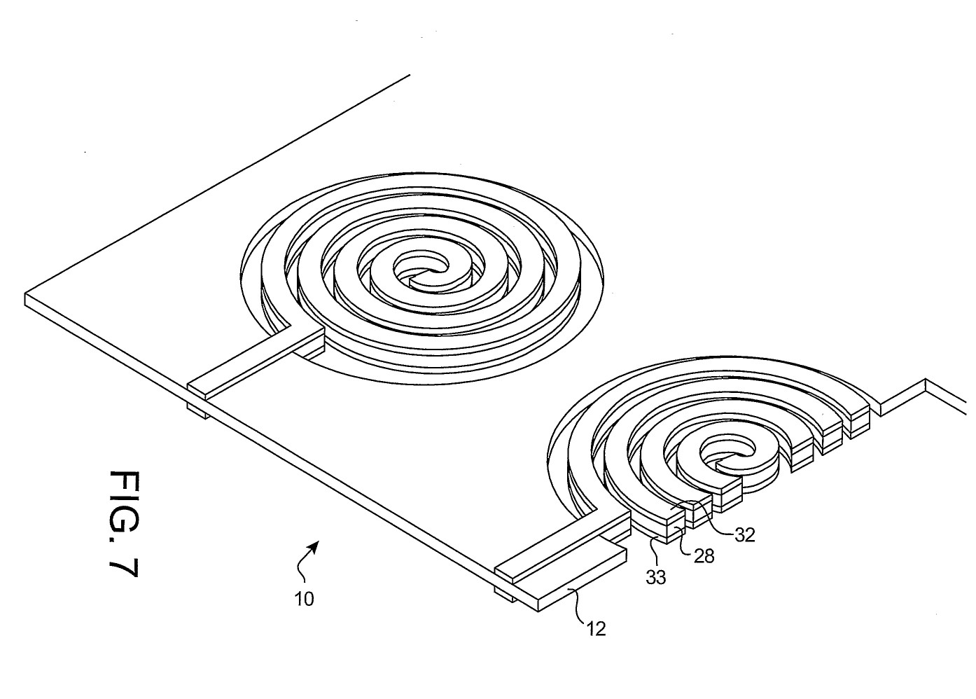

FIG. 6 shows an assembly of 4 taxels intended to show the means of thermal separation between adjacent taxels in a monolithic touch plate.

FIG. 7 shows a perspective view of another embodiment with an elastic means of return present, which is applicable in particular to cases where the tactile sensation is obtained in vibratory mode using a piezoelectric material,

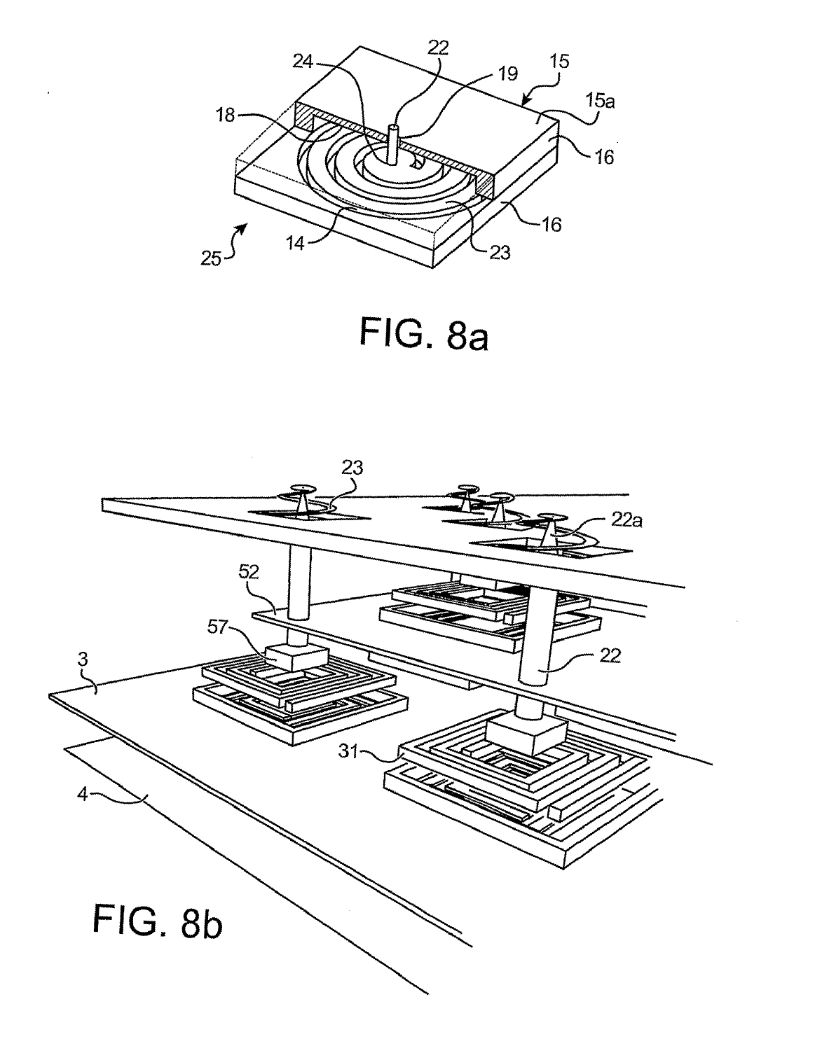

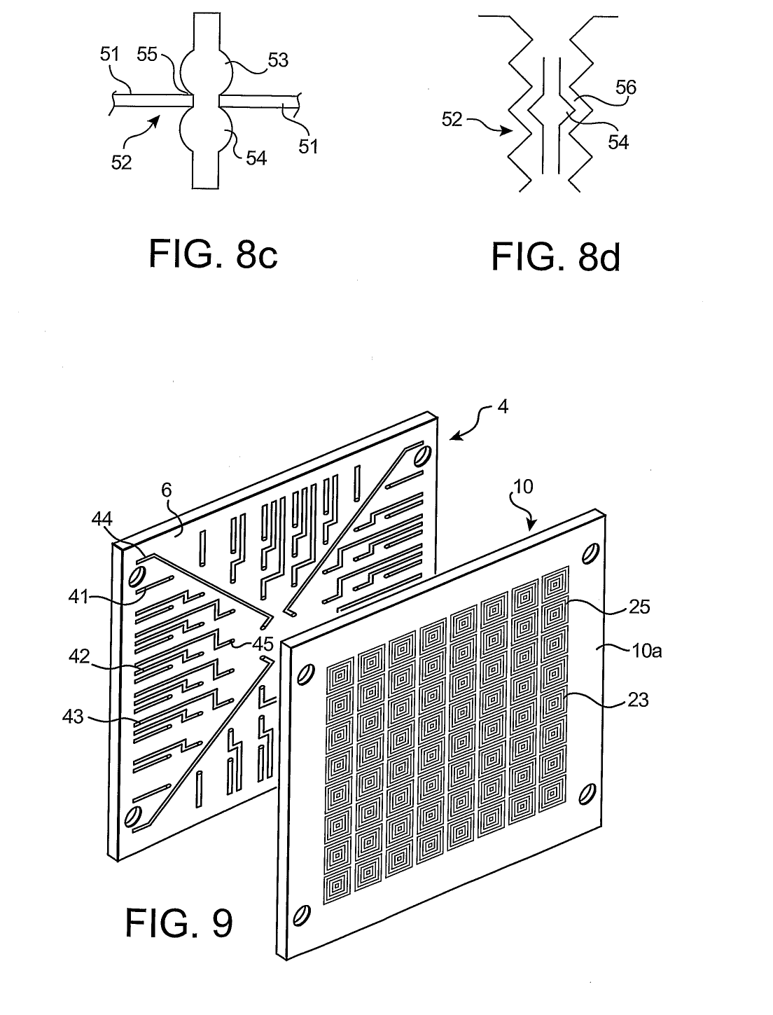

FIG. 8a is an example of an embodiment in which the taxel strip indirectly causes modification of the tactile sensation, with the strip only used as the motor element of another element,

FIG. 8b is an example of an embodiment in which the taxel strip is a guidance element of a rod which is itself actuated by a coil-magnet assembly,

FIGS. 8c and 8d show details of manufacture for making bi-stable or multi-stable taxels respectively.

FIG. 9 shows an exploded perspective view of an example of a tactile display device in the form of two layers or two plates placed one on top of the other, a touch plate and a plate bearing an addressing circuit,

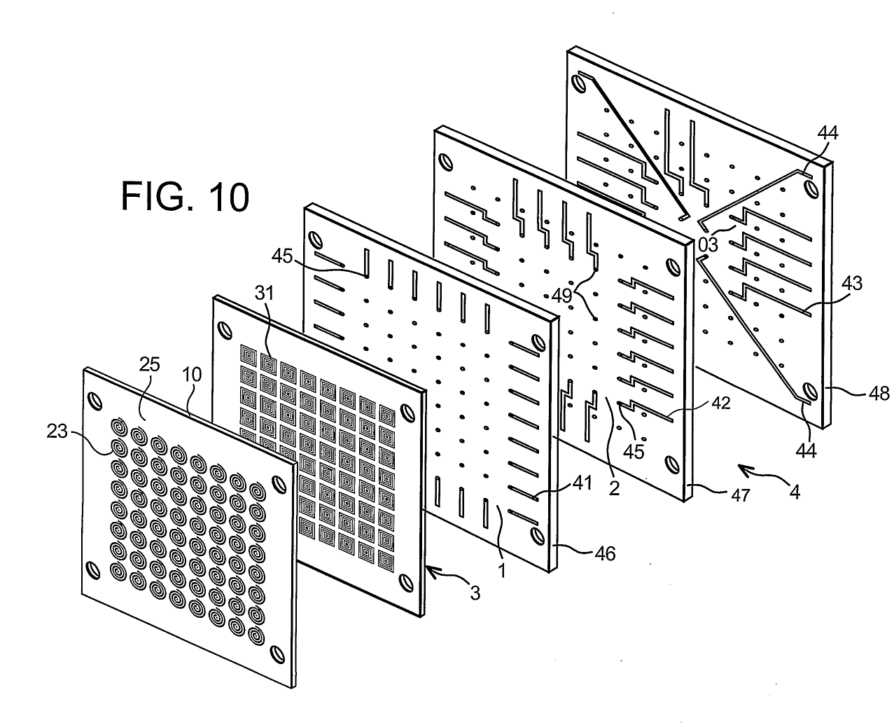

FIG. 10 shows an exploded view of one embodiment in the form of several superimposed layers or plates, with one touch plate including strips which are sensitive to magnetic fields, a layer or plate of coils, and an addressing circuit for the coils in the form of one or more layers.

### DETAILED DESCRIPTION OF SPECIFIC CONSTRUCTION OPTIONS

FIG. 1 represents a plate 10 which has an upper surface 10a which includes an assembly of taxels 25. The taxels 25 make up a network, for example a regular bitmap pattern in lines and columns as shown in FIG. 1. The distance separating the centre 24 of one taxel from the centre 24 of an adjacent taxel is typically of the order of millimetres. This resolution effectively represents the mechanical resolution of human finger tips. In accordance with the invention, each of the taxels 25 is formed of a strip 23 in the form of a spiral, that is, a strip in which a central longitudinal line spirals from a peripheral part towards the centre 24. Each point of intersection between this line central longitudinal line and a radius from the centre is closer to the centre 24 than the point of intersection for the previous turn. In FIG. 1 each taxel strip has a circular spiral shape. The shape is not mandatory. The spiral could have any other spiral shape, for example square, oval or otherwise. In FIGS. 2a and 2b which represent an enlarged perspective view of an isolated taxel in its resting state and working state respectively, the strip 23 has a circular spiral shape. The shape at rest of the strip 23 of taxel 25, made of, for example, shape memory alloy (alliage à mémoire de forme—AMF), is the shape in which strip 23 is in the plane of the plate 10. The working shape is the memorised shape in which the strip 23 is out of the plane. Each strip 23 is formed by being cut from a gap 14, itself in the form of a spiral. One non-central end 26 of the strip 23 is linked to a solid part of the plate 10 through a junction 26 which forms an anchorage arm for the strip 23. In the rest position, the strip 23 is as shown in FIG. 2a in the local plane of the plate 10. In the working position, the strip 23 is as shown in FIG. 2b out of the local plane 10. It therefore exhibits a surface contour which is used to give a tactile sensation.

In a second embodiment the strip 23 of each taxel 25 has a double spiral shape. A taxel 25 in accordance with this embodiment is shown in FIG. 3a in the rest position and 3b in the working position. The spiral formed by the strip 23 is known as a double spiral since a path along a central longitudinal line of the strip, from a first link arm 26 between a peripheral part of the strip and a solid part of the plate moves towards the centre 24 of the strip, at the centre 24 forms a point at which it turns back on itself and starts back towards a second link arm 27 between a peripheral part of the strip and a solid part of the plate.

The arms 26, 27 which are on the peripheral parts of the strip stay in a fixed position in the plane of the plate 10, irrespective of whether the strip 23 is in the in-plane or out-of-plane state. This means that electrical connections between the first and second arms 26, 27 respectively and an addressing circuit, are fixed.

In the shapes represented in FIGS. 2a, 2b or 3a, 3b, the taxels 25 may be formed in a touch plate 10 made of single or double direction shape memory material, of piezoelectric material, for example a piezoelectric ceramic, electrostrictive material, for example an electrostrictive ceramic or of a magnetostrictive material.

When the plate 10 or one of its sub-plates or layers of which it is formed is made of shape memory material, the change from the rest position to the working position is achieved by heating. This is achieved for example by causing a current to pass directly through the strip 23 made of shape memory material or by using a thermistor or a heating resistance placed close by, heating by conduction or by radiation or by any other source of heat, and in particular a laser beam.

When the plate 10 or one of its sub-plates or layers from which is it formed is made of piezoelectric material, for example a piezoelectric ceramic or an electrostrictive material, for example an electrostrictive ceramic, a deformation in the contours may be achieved by the application of a voltage between an upper part and a lower part of this material.

The rest form is a shape in which little or no voltage is applied to the strip 23. The working form is a shape in which a variable voltage is applied to the strip 23, for example an alternating voltage, which causes a vibration effect which may be detected in a tactile manner.

Magnetostriction allows “high torque, high-speed” actuators to be made directly without the need to pass through a reducer. Alloys such as iron-cobalt may be deposited onto a substrate as in the previous piezoelectric case. A magnetic field is required to re-align the magnetic dipoles and generate deformations. These individual magnetic fields must be close to each magnetostrictive taxel. One embodiment of such fields will be presented later on.

In the variants which are applicable to display devices which include taxels 25 which involve strips 23 made of single direction shape memory or piezoelectric or electrostrictive or magnetostrictive materials such as those represented in FIGS. 2a, 2b or 3a, 3b a means of returning the strip 23 of a taxel 25 from its out-of-plane position to its in-plane position is required. This is not so when the material is double-direction shape memory material.

In one variant, where a means of return is present, the means of return is a result of the fact that the shape memory material is a dual direction material. The return to the in-plane position, which is the low temperature position in this case, is achieved due to thermal treatment carried out beforehand which produces what is known as the double direction effect in shape memory alloys. Thus the embodiments shown in any of FIGS. 2a, 2b; 3a, 3b, correspond to embodiments with return achieved using plates 10 made of double direction shape memory materials.

In a second variant, with a means of return present, the return to the in-plane position is accelerated by the presence of elastic means 28. This means with elastic return is applicable in cases where the material forming one of the sub-plates of the plate of the plate 10 is a shape memory or piezoelectric or electrostrictive or magnetostrictive material.

In one embodiment of this variant where an elastic means of return 28 is present, shown in FIG. 4, the elastic means are a spring 28 which has the same dimensions as the active strip 23. In this case the touch plate 10 takes the form of a bi-layer plate, a first sub-plate 11 made of shape memory or piezoelectric or electrostrictive or magnetostrictive material, and a second sub-plate 12 made of elastic material which is solidly fixed to the first sub-plate 11. In the example shown in FIGS. 4 the spring 28 is cut out in the same manner as the strip 23. In particular, the centres 20 of the spring 28 on plate 12 and 24 of the strip 23 of the first sub-plate 11 are located one beneath the other and are mechanically firmly fixed together.

In another embodiment of this variant where there is an elastic means of return 28 present, the passive spring 28 has for reasons of stiffness and return force, a spiral geometry which differs from that of the active spring 23. In this case the two sub-plates 11 and 12 are not fully mechanically fixed to each other and a single point of solder, for example, provides a mechanical link between the centre 24 of the strip 23 made of shape memory or piezoelectric or electrostrictive or magnetostrictive material, and the centre 20 of the spring 28 cut from the sub-plate 12. This other embodiment of the second variant is not shown.

The spring 28 is made of a passive material which has interesting elastic characteristics, for example spring steel.

In another variant where there is a means of return present, return is achieved by a shape memory material which has a memorised shape which is antagonistic to that of the strip 23. Such a embodiment is shown in FIG. 5.

In this case the touch plate 10 is in the form of a bi-layer plate, a first sub-plate 11 made of shape memory material and a second sub-plate 13 also made of shape memory material, firmly fixed to the first sub-plate 11. In the example shown in FIG. 5 a spiral return strip 29 is cut into the second sub-plate 13, in the same way as the strip 23 in the first sub-plate 11.

Preferably, in this embodiment with return to the rest position by a strip 29 made of shape memory material, with a memorised shape which is antagonistic to that of the active strip 23, both sub-plates 11, 13 are separated from each other by thermal insulation. This means that the active strip 23 and the return strip 29 may be heated independently. This embodiment is particularly suitable in the case shown in FIGS. 3a, 3b where there is a double spiral, since an addressing circuit then includes a common supply track for one of the ends of the means of heating one of the strips 23 or 29 of the same taxel 25, and tracks which are independent of each other for the other end of each of the means of heating of the said taxel 25. The means of heating of strips 23 and 29 respectively may thus be supplied independently of each other.

In a first mode of thermal separation of strips 23 and 29 of the same taxel 25 shown in FIG. 5, a thermally insulating layer 30, made, for example, of polymer, is introduced between the two sub-plates 11 and 13. Electrically conductive paths not represented which pass through the insulating layer 30 provide a common electrical supply of an electrically common end of a means of heating one or other of the strips 23, 29.

In a second mode of thermal separation which is not shown, the sub-plates 11, 13 are thermally insulated from each other by an assembly of thermally insulating beads arranged between the centres of each strip 23 and each strip 29 of the same taxel 25. optionally, for all the modes in which the taxels in the touch plate 10 react to a thermal effect the touch surface 10a is covered with a thermally insulating layer 50, shown in FIG. 3a, so as not to directly heat the finger tips.

It is advantageous when a strip 23 is heated to its temperature for transformation from the martensitic state to the austenitic state in order to move from the in-plane position to the out-of-plane position, if the thermal flux supplying a strip 23 is not transmitted to neighbouring strips 23 of taxels 25, so as not to induce unwanted movement in the strips 23 of these taxels. It is therefore of interest to increase the thermal resistance between neighbouring taxels 25. FIG. 6 shows an illustration of this concept for 4 neighbouring taxels 25 in a monolithic plate 10 in which the total number of taxels is not limited to the four shown in FIG. 6. In order to increase the thermal path between consecutive neighbouring taxels 25, one, or preferably more, grooves 21 are arranged between two consecutive taxels. The grooves are arranged between consecutive taxels 25 in order to increase the thermal path between two strips 23 of consecutive taxels 25. Because of the presence of grooves 21, the touch plate 10 becomes more mechanically flexible which is sometimes an advantage when the finger comes into contact with the plate. The plate 10 deforms locally and fits the profile of the finger or any other bodily contact zone and improved tactile performance is obtained as a result of this.

Another embodiment with an elastic means of return 28 present which is applicable in particular to cases where the tactile sensation is obtained using a piezoelectric material, is shown in FIG. 7.

In this embodiment the touch plate 10 takes the form of a triple-layer material in which a layer 28 made from a material which has interesting elastic properties, for example steel, copper or beryllium, is sandwiched between two layers 32, 33 of piezoelectric material. This triple-layer material may in particular be made by deposition of a piezoelectric ceramic, for example using sol-gel deposition technologies. Thus when an electrical field is applied to 2 piezoelectric layers, it produces deformation in flexure which causes deflection out of the plane.

One embodiment example will now be described in connection with FIG. 8a in which the strip 23 indirectly causes modification of the tactile sensation. The strip 23 is only used as a motor element for another element, for example a rod 22 which is mechanically connected to the strip, with this other element 22 being level with or protruding from the touch plate 10 depending on the state of the strip 23. In the case of indirect modification, it is this other component 22 which sets up the modification of the tactile sensation. The strip directly sets up the modification of the tactile sensation when the strip itself, perhaps through a protective intermediate, comes into contact with the finger of a user.

In the embodiments which have been described and in their variants each strip 23 directly sets up the modification of the tactile sensation.

In the example shown in FIG. 8a, the tactile display device according to the invention includes a touch plate 10 formed from 2 sub-plates or layers 16, 17. The sub-plate 16 includes, in accordance with the invention, for each taxel 25, a strip 23 separated from a solid part of the sub-plate 16 by a gap 14. The rod 22 is fixed to the centre 24 of the strip 23. The rod 22 is perpendicular to the local plane of the sub-plate 16. The sub-plate 17 is placed above and mechanically firmly fixed to the sub-plate 16. The sub-plate 17 includes opposite every taxel of the sub-plate 16 a cavity 18 whose dimensions are sufficient to house the strip 23 when it is in the out-of-plane position. The cavity 18 in the preferred embodiment has an effectively truncated conical form. A through hole 19 is located in the narrow end of the cavity 18, which allows the rod 22 to pass through and be guided. The upper surface 15a of the touch plate 15, formed by the upper surface of the sub-plate 17 is the touch surface.

This embodiment with the addition of a rod 22 at the centre 24 of each strip 23 is compatible with each of the embodiments which have been described above.

The operation is as follows:

When any stress is applied to the strip 23, the rod 22 is completely housed in the hole 19, or partially in the hole 19 and cavity 18, so that the rod does not protrude from the upper surface 17 of the touch plate 10.

When the strip 23 is deformed by the application of heat if the material making up the sub-plate 16 is a shape memory material, or by the application of an electric field if a piezoelectric or electrostrictive material is involved, or by application of a magnetic field if a magnetostrictive material is involved, the rod 22 is pushed upwards so that it continuously or periodically protrudes from the surface 17a of the sub-plate 17, thus modifying the tactile sensation at this surface.

In the examples which have just been described, the role of the strip 23 is an active one in that it is the strip which deforms under the action of a physical phenomenon. It could possibly drive a pin 22. Cases will be described below in connection with FIG. 8b in which the strip 23 acts as a guidance element for a rod or pin 22 which acts as a tactile pin. In this case the strip is cut as previously described from a solid part of a plate 10 which forms the touch plate. In this case the material which forms the aforementioned plate is an elastic material, for example spring steel or beryllium copper. A pin 22 which forms a push-rod has one end 22a mechanically connected to the centre 24 of a strip 23. The flexible guide system allows significant movement without the limits to the elastic zones of the material making up the strip being exceeded. The pin 22 has a second end which is mechanically connected to a magnet 57 whose movement towards a touch plate 10 or away from this is achieved by means of the direction of the current passing through a coil 31 associated with each pin 22. An intermediate guide plate 52 is preferably inserted between the touch plate and a plate 3 which carried the coils 31. The pin is not necessarily in the form of a rod as shown in FIG. 8b. It could as shown in FIGS. 8c and 8d have a shape which shows variations in transverse section dimensions, with the narrow sections forming the locking position end stops. Thus in FIG. 8c the rod 22 has two bulges 53, 54 separated from each other by a narrow part 55. In the locked position the elastic strips 51 formed around a passageway for the rod 22 through the plate 52 come up against the narrow part 55. In FIG. 8d the rod 22 shows a bulge 54 and the intermediate plate 52 shows notches 56 over its thickness. Each notch 56 in combination with the bulge 54 forms a position for locking the rod 22.

The operation is as follows:

Each rod or pin 22 is suspended on a strip 23 of the touch plate. Depending on the direction of the current flowing in the coil 31 the rod has a high position pushing the strip 23 out of the plane or a low position bringing it back into the plane.

Embodiments of the addressing circuit for applying heating currents or voltages or magnetic fields in a selective manner to the pixels 25 of the touch plate 10 will now be described in association with FIGS. 9 and 10.

For a single spiral as shown in FIGS. 2a, 2b, in order to supply a current to a strip 23 made of a shape memory material or to a thermistor or to a heating resistance deposited on the strip 23, a mobile electrical supply connector, for example in the form of a conductor wire, is fixed, for example, to the centre 24 of the strip 23. This connection provides an electrical connection from the first end 26 of the strip made from shape memory material or to the thermistor or heating resistance otherwise, to an end 45 of a track 41, 44 of an addressing circuit 4, which will be briefly described hereafter.

As shown in FIG. 9, the addressing circuit 4 may be made in the form of a printed circuit 4 which includes tracks 41-44, each connecting an external edge of the circuit to a position which corresponds to a centre 24 of a taxel 25. The tactile display device is therefore in the form of two layers or two plates 4, 10, which are placed one above the other as shown in an exploded perspective in FIG. 9.

The operation is as follows: A control device, not shown, connects the side ends of the tracks 41-44, depending on the motifs to be shown on the touch plate 10, to an electrical supply which is not represented. A current therefore flows from the selected track to the element which heats the strip 23 which corresponds to each of the selected tracks. The current returns through a common earth. When the strips 23 selected have reached their transformation temperature, the aforementioned strips return to their memorised out-of-plane shapes, thus forming the motif to be created.

An addressing circuit 4 such as shown in FIG. 9 may also be used for addressing voltages if the strips 23 are cut from a plate made of piezoelectric or electrostrictive material. In this case connections 45 are connected to a control electrode attached to the material of the strip 23. Another electrode is connected to a constant potential.

In the case where the material making up the plate is a magnetostrictive material, it is appropriate to apply a selective magnetic field to each taxel. In order to create a variable magnetic field, a circuit 3 of coils 31 is included between the addressing circuit 4 and the touch plate 10.

In the case where the material which makes up the plate is a magnetic material and where the strips 23 are cut from this material, a vibratory tactile effect is obtained by applying an alternating current to the coils 31.

FIG. 10 shows an exploded view of one example of this embodiment mode. This figure show a layer 3 of flat coils 31 and three layers 46-48 making up a multi-layer addressing printed circuit 4. In the representation in FIG. 10, the layer 3 of coils 31 includes, with simplification of representation in mind, only eight columns of eight lines of coils 31. Addressing is achieved through tracks 41-44 of the multi-layer circuit 4 coming into contact with the centre of the coils. Each coil 31 may therefore be addressed independently. This configuration of the addressing circuit 4 is of great interest when the number of coils 31 and corresponding taxels 25 is very large.

1-15. (canceled)

16. A tactile display device comprising:
a touch plate with a touch surface;
a network of taxels formed in solid parts of the touch plate or in solid parts of a sub-plate that forms part of the touch plate with each taxel made up of a strip that can be in at least two states, with a change from one state to another state indirectly or directly modifying tactile sensation;
means for modifying the state of the taxel strips in a selective manner, the means including means for addressing and means for modifying the taxels tactile sensation,
wherein each taxel strip has a spiral shape, bordered on either side by a gap in a form of a spiral.

17. A tactile display device according to claim 16, wherein each taxel strip has a double spiral shape.

18. A tactile display device according to claim 16, wherein the plate or a sub-plate which together with at least one other sub-plate form the touch plate, and the taxel strips are made from a shape memory material, with each strip capable of two states, depending on its temperature, including a first state in which the strip is in a local plane of the plate or of the sub-plate, and a second state in which the strip is deformed out of the plane, thus causing a tactile surface contour sensation.

19. A tactile display device according to claim 18, wherein the shape memory material from which the plate or sub-plate and strips are made is a double direction material.

20. A tactile display device according to claim 18, wherein the touch plate is made of two sub-plates that are parallel to each other, one sub-plate made of shape memory material that includes the taxel network and a sub-plate made of elastic material, where the sub-plate made of elastic material includes, so as to correspond with each taxel in the sub-plate made of shape memory material, a spring strip separated from the solid part of the sub-plate by one or more gaps and linked to the solid part by one or more arms, with each spring strip on the sub-plate made of elastic material including a rigid mechanical link with the spiral strip of the taxel to which it corresponds, so as to exert a return force on this taxel strip when this taxel strip is in its out-of-plane state.

21. A tactile display device according to claim 18, wherein the touch plate is made of two sub-plates that are parallel to each other, one sub-plate made of shape memory material that includes the taxel network and a return sub-plate also made of shape memory material, with the return sub-plate including, so as to correspond with each taxel in the sub-plate made of shape memory material that holds the taxel network, a strip separated from the solid part of the return sub-plate by one or more gaps and that is linked to the solid part by one or more arms, with each strip on the return sub-plate being, depending on its temperature, in a rest position or in a memorized position, with each strip in the return sub-plate including a rigid mechanical link with the spiral strip of the taxel to which it corresponds so that in a memorized position the strip in the return sub-plate exerts a return force on the taxel strip to which it corresponds, which tends to bring the said taxel strip from its out-of-plane state to its at-rest state.

22. A tactile display device according to claim 21, wherein a thermal insulation layer separates the sub-plates made of shape memory material from each other, wherein the rigid mechanical link between one strip of the return sub-plate and the taxel strip to corresponds includes a thermal insulation element rigidly linked mechanically to a part of the taxel strip and to a part of the strip on the return sub-plate.

23. A tactile display device according to claim 18, wherein grooves are present in the solid parts part of the plate or sub-plates made of shape memory material that forms the touch plate assembly, in the spaces between two strips.

24. A tactile display device according to claim 16, wherein the touch plate includes a bi-layer material that includes one layer of elastic material and one layer of piezoelectric material.

25. A tactile display device according to claim 16, wherein the touch plate includes a triple-layer material that includes one layer of an elastic material between two layers of piezoelectric material.

26. A tactile display device according to claim 16, wherein the touch plate is made up of a bi-layer material that includes two layers of piezoelectric material.

27. A tactile display device according to claim 16, wherein the touch plate includes one layer of magnetostrictive material or of an electrostrictive material.

28. A tactile display device according to claim 16, wherein the taxel strip is a motor element of a rod that sets up a modification of the tactile sensation at the touch plate.

29. A tactile display device according to claim 16, wherein the strips are mechanically linked to a rod which is itself mechanically linked to a magnet.

30. A tactile display device according to claim 28, further comprising an intermediate plate made of deformable material, which includes passageways for rods, wherein the rods have bulging parts and narrow parts, with these bulging and narrow parts fitting into the internal shapes in the passageways to maintain the rod in one or more pre-defined positions.
